(19) United States
(12) Patent Application Publication
(10) Pub. No.: US 2013/0129045 A1
(43) Pub. Date: May 23, 2013

(54) TRANSMISSION TYPE RADIATION GENERATING SOURCE AND RADIOGRAPHY APPARATUS INCLUDING SAME

(71) Applicant: CANON KABUSHIKI KAISHA, Tokyo (JP)

(72) Inventors: Takao Ogura, Yokohama-shi (JP); Shuji Aoki, Yokohama-shi (JP); Miki Tamura, Kawasaki-shi (JP); Kazuyuki Ueda, Tokyo (JP); Yoshihiro Yanagisawa, Fujisawa-shi (JP); Yasue Sato, Machida-shi (JP); Ichiro Nomura, Atsugi-shi (JP); Koji Yamazaki, Ayase-shi (JP)

(73) Assignee: CANON KABUSHIKI KAISHA, Tokyo (JP)

(21) Appl. No.: 13/677,134

(22) Filed: Nov. 14, 2012

(30) Foreign Application Priority Data
Nov. 18, 2011 (JP) 2011-252792

(51) Int. Cl. H01J 5/18; G01N 23/04

(52) U.S. Cl. CPC H01J 5/18; G01N 23/04
USPC 378/62; 378/140

(57) ABSTRACT

A transmission type radiation generating device includes an electron emitting source; a substrate that transmits radiation; a target provided on a surface of the substrate facing the electron emitting source and configured to generate radiation when electrons emitted from the electron emitting source are applied thereto; a shield member having a radiation passage that allows the radiation transmitted through the substrate to pass therethrough, the shield member being connected to the substrate and including at least a forward shield portion that protrudes in a direction away from the electron emitting source with respect to the target; and an insulating fluid in contact with the forward shield portion. The shield member includes a low-melting-point metal or a low-melting point alloy provided at least in the forward shield portion.

### BACKGROUND OF THE INVENTION

1. Field of the Invention

The present invention relates to a transmission type radiation generating device and a radiography apparatus including that device. These devices may be applicable to diagnosis in the field of medical devices, nondestructive X-ray photography in the field of industrial devices, and the like.

2. Description of the Related Art

In a radiation generating device used as a radiation source, electrons emitted from an electron emitting source are made to impinge upon a target made of metal having a high atomic number, such as tungsten, whereby radiation is generated. The radiation generated from the target is emitted in all directions. Therefore, a portion of the radiation unnecessary for imaging is blocked by providing one or more shield members made of radiation-blocking material, such as lead. This increases the size and weight of the radiation generating device. Japanese Patent Application Laid-Open No. 2007-265981 discloses a transmission type radiation generating device in which shield members are provided on an electron incident side and on a radiation emitting side of a transmissive target. In such a transmission type radiation generating device, there is no need to cover the entirety of a transmission type radiation generating tube or a housing that houses the transmission type radiation generating tube with a shield member made of lead or the like. Therefore, the size and weight of the device can be reduced.

To generate radiation suitable for radiography, a high-energy electron beam needs to be applied to the target by applying a voltage as high as 40 kV to 150 kV between the electron emitting source and the target. In general, however, the efficiency of radiation generation is very low. Specifically, about 99% of power consumed is dissipated as heat from the target. Since the target comes to have a high temperature with the heat thus generated, a member that prevents thermal damage to the target is necessary. Japanese Patent Application Laid-Open No. 2004-351203 discloses, in paragraph [0021] therein, a technique in which cooling passages made of a heat storage material are provided below a reflective target provided in a target base member. In this manner, heat generated from the target is dissipated and the rise of temperature in the target is suppressed.

According to Japanese Patent Application Laid-Open No. 2007-265981, when electrons impinge upon the transmissive target, heat generated from the target is diffused through the two shield members, whereby the rise of temperature in the target is suppressed. Since the two shield members are provided in a vacuum, a large portion of the heat is considered to be dissipated in the form of radiant heat. Radiant heat is proportional to the fourth power of a body's thermodynamic temperature T. That is, radiant heat does not tend to dissipate until it reaches a high temperature. Therefore, in Japanese Patent Application Laid-Open No. 2007-265981, a function that dissipates the heat generated from the target is provided. Nevertheless, if energy input to the target is large, heat dissipating performance of the function is not necessarily satisfactory.

In the reflection radiation generating device according to Japanese Patent Application Laid-Open No. 2004-351203, the cooling passages made of a heat storage material are provided below the reflective target. To apply the cooling passages to a transmission type radiation generating device, the cooling passages need to be provided in a substrate supporting a transmissive target. Since the substrate needs to transmit radiation and is therefore thin, it is difficult to provide such cooling passages made of a heat storage material in the substrate.

As described above, transmission type radiation generating devices have a problem in realizing satisfactory heat dissipating performance that causes heat generated from a target to dissipate efficiently even if energy input to the target is large.

### SUMMARY OF THE INVENTION

The various embodiments of present invention are generally directed to a transmission type radiation generating device and a radiography apparatus including the same that realize satisfactory heat dissipating performance that causes heat generated from a target to dissipate efficiently and include a function that blocks an unnecessary portion of radiation.

According to a specific aspect of the present invention, a transmission type radiation generating device includes an electron emitting source configured to generate an electron beam; a substrate that transmits radiation therethrough; a target provided on a surface of the substrate facing the electron emitting source and configured to generate radiation when electrons emitted from the electron emitting source impinge thereupon; a shield member having a radiation passage that allows the radiation transmitted through the substrate to pass therethrough, the shield member being connected to the substrate and including at least a forward shield portion that protrudes in a direction away from the electron emitting source; and an insulating fluid that is in contact with the forward shield portion. The shield member includes a low-melting-point metal or a low-melting-point alloy provided at least in the forward shield portion.

According to the above aspect of the present invention, the transmission type radiation generating device includes the forward shield portion protruding in the direction away from the electron emitting source with respect to the target, i.e., toward the front side with respect to the target, and the forward shield portion includes the radiation passage. Therefore, an unnecessary portion of the radiation transmitted through and emitted from the substrate is blocked. Furthermore, the forward shield portion includes the low-melting-point metal or the low-melting-point alloy. Therefore, when the temperature of the low-melting-point metal or the low-melting-point alloy reaches its melting point, an amount of heat corresponding to the amount of heat of fusion of the low-melting-point metal or the low-melting-point alloy is absorbed in replacement of the heat of fusion. Hence, the rise of temperature in the target is suppressed. Furthermore, when the low-melting-point metal or the low-melting-point alloy included in the forward shield portion has entirely melted, the molten low-melting-point metal or the low-melting-point alloy comes to have different temperatures in its different regions, causing thermal convection. Hence, the rise of temperature in the low-melting-point metal or the low-melting-point alloy is suppressed. Consequently, the rise of temperature in the target is suppressed, and the rise of temperature in the substrate and the forward shield portion is also suppressed. Thus, the target can be cooled efficiently, realizing irradiation at higher current and for a longer time.

Further features of the present invention will become apparent from the following description of exemplary embodiments with reference to the attached drawings.

### BRIEF DESCRIPTION OF THE DRAWINGS

FIGS. 1A and 1B are longitudinal and lateral sectional views, respectively, of a transmission type radiation generating device according to a first embodiment of the present invention.

FIG. 2 is an enlarged sectional view illustrating a shield member and associated elements included in the radiation generating device according to the first embodiment.

FIG. 3 illustrates the thermal convection of a low-melting-point metal or alloy included in a forward shield portion of the shield member illustrated in FIG. 2 that occurs when the low-melting-point metal or alloy has melted.

FIG. 4 is an enlarged sectional view illustrating a shield member and associated elements included in a radiation generating device according to a second embodiment of the present invention.

FIG. 5 is an enlarged sectional view illustrating a shield member and associated elements included in a radiation generating device according to a third embodiment of the present invention.

FIG. 6 is an enlarged sectional view illustrating a shield member and associated elements included in a radiation generating device according to a fourth embodiment of the present invention.

FIG. 7 is a sectional view of a multiple radiation generating device including a plurality of units each including an electron emitting source and a substrate, a target, the shield member, and the low-melting-point metal or alloy that are illustrated in FIG. 6.

FIG. 8 is a schematic diagram of a radiography apparatus including the radiation generating device according to any of the embodiments of the present invention.

### DESCRIPTION OF THE EMBODIMENTS

Referring to the attached drawings, exemplary embodiments of the transmission type radiation generating device (hereinafter simply referred to as “radiation generating device”) according to the present invention will now be described in detail. The materials, dimensions, shapes, relative positions, and so forth of elements described in the following embodiments do not limit the scope of the present invention unless specifically stated.

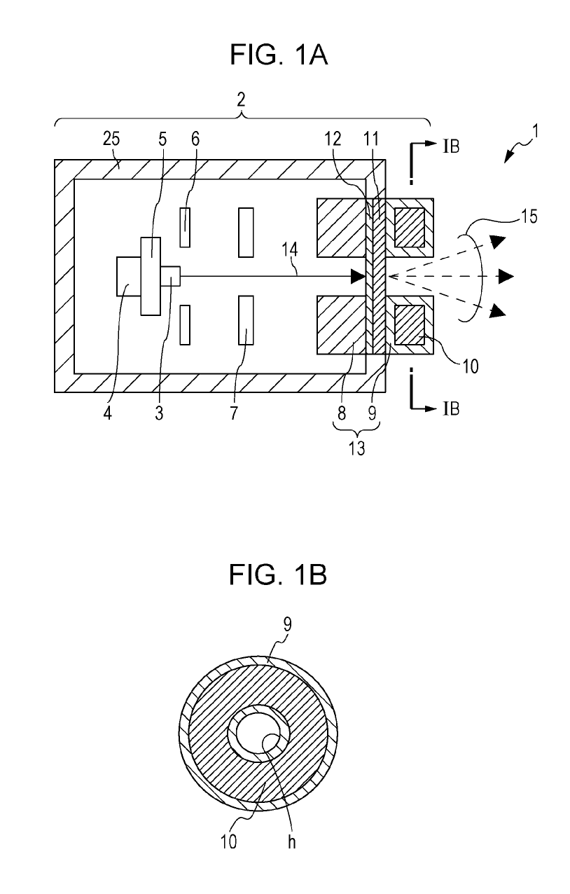

Referring to FIGS. 1A and 1B, a configuration of a radiation generating device 1 according to a first embodiment of the present invention will be described. FIG. 1A is a longitudinal sectional view of the radiation generating device 1 according to the first embodiment. FIG. 1B is a lateral cross-sectional view taken in a virtual plane extending along line IB-IB illustrated in FIG. 1A. FIGS. 1A and 1B illustrates only a radiation generating tube as a vacuum container 2 including a container 25 (a cylindrical structure closed on one end) that is sealed by a combination of a substrate 11 and a target 12. FIG. 1A does not illustrate a housing that houses the vacuum container 2 and an insulating fluid such as an atmosphere or insulating oil provided between vacuum container 2 and the housing. The elements not shown in FIG. 1A are not within the scope of the present disclosure, and are considered to be well known to persons having ordinary skill in the art. Therefore, these elements are omitted for the brevity.

An electron emitting source 3 emits electrons in the form of an electron beam 14. The electron emitting source 3 may include, as a cathode, either a cold cathode or a hot cathode. If an impregnated cathode (a hot cathode) is applied to the electron emitting source 3 of the radiation generating device 1, a high current can be stably extracted even if the degree of vacuum is relatively high. The electron emitting source 3 is integrated with an insulating member 5 in the first embodiment.

A heater 4 is provided near the cathode. When energized, the heater 4 raises the temperature of the cathode and causes the cathode to emit electrons.

A grid electrode 6 is an electrode to which a predetermined voltage is applied so as to extract electrons generated from the cathode, i.e., the electron emitting source 3, into the vacuum and is provided at a predetermined distance from the electron emitting source 3. The shape, opening size, opening ratio, and so forth of the grid electrode 6, which is provided at a distance of about several hundred microns from the cathode, are determined such that the current reaches the target 12 efficiently, taking into consideration the exhaust conductance near the cathode. Typically, a tungsten mesh having a wire diameter of about 50 μm is used. The grid electrode 6 is not an essential member of the radiation generating device according to the present invention.

A focusing electrode 7 is an electrode that controls the focus diameter of the electron beam 14 at the target 12. The electron beam 14 is extracted from the cathode by the grid electrode 6. The focus diameter determines a circular focus area at the target 12. Typically, a voltage of about several hundred volts to several thousand volts (kilovolts kV) is applied to the focusing electrode 7 for adjustment of the focus diameter. Alternatively, the focusing electrode 7 may be omitted. Instead, the electron beam 14 may be focused only through the application of a predetermined voltage to the grid electrode 6, which exerts a lens effect.

The anode (not illustrated) is an electrically conductive member that is electrically connected to the target 12 according to need. The anode has acceleration energy that causes the target 12 to emit radiation, and defines an anode potential for the target 12 that is required for causing electrons to impinge upon the target 12. The anode is connected to at least a voltage source (not illustrated) that supplies a voltage potential to the anode. Alternatively, or in addition thereto, the anode may be connected to the target 12 with a shield member 13. The shield member 13 includes at least a forward shield portion 9 or a bonding member (not illustrated) with the anode being interposed therebetween. It is also acceptable that the vacuum container 2 does not include an anode member that is separate from the target 12. In that case, the target 12 itself can function as an anode and can be electrically connected to the voltage source that supplies the anode potential, with a certain conductive member interposed therebetween. The anode may alternatively be provided as a member that forms part of the vacuum container 2 and is connected to the container 25. A voltage of about several dozen kilovolts to a hundred kilovolts is applied to the anode, whereby the anode functions as a positive terminal paired with the cathode (a negative terminal) included in the electron emitting source 3. The electron beam 14 generated by the electron emitting source 3 and extracted by the grid electrode 6 is focused on the focus area on the target 12 by the focusing electrode 7, is accelerated by the voltage applied to the anode, and impinges upon the target 12, whereby radiation 15 is generated. The radiation 15 is extracted to the outside of the vacuum container 2 through the substrate 11 functioning as a radiation transmitting window.

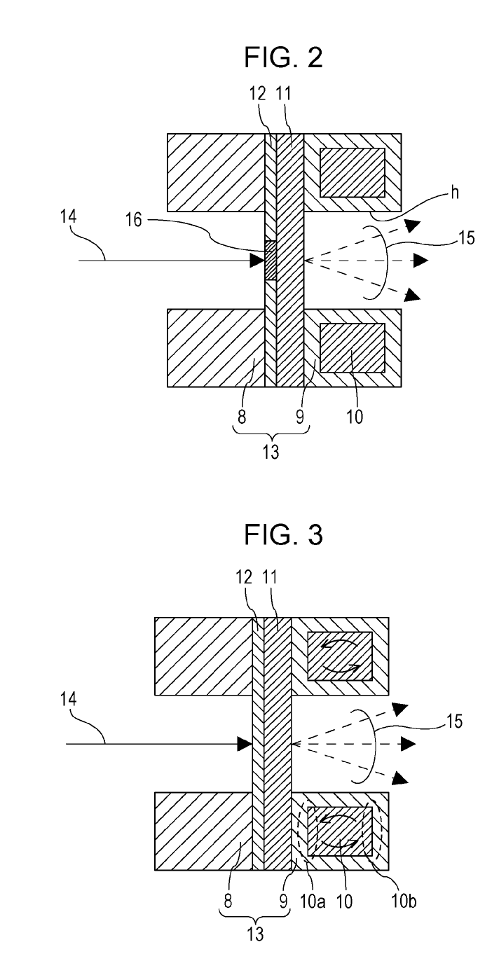

Referring now to FIG. 2, the shield member 13, a low-melting-point metal or alloy 10, the substrate 11, and the target 12 included in the radiation generating device 1 according to the first embodiment of the present invention will be described in detail. FIG. 2 is an enlarged sectional view illustrating the shield member 13 and associated elements included in the radiation generating device 1 according to the first embodiment.

The target 12 is provided on a surface of the substrate 11 that faces the electron emitting source 3 and generates radiation when electrons emitted from the electron emitting source 3 are applied thereto (when the electron beam 14 having a predetermined energy impinges upon the target 12). Typically, the target 12 is made of metal whose atomic number is 26 or larger, or a material having a high thermal conductivity and a high melting point. In such a case, the temperature of an electron-beam application area 16 of the target 12 becomes very high, and the heat generated from the electron-beam application area 16 is quickly transmitted to a backward shield portion 8, the forward shield portion 9, and the low-melting-point metal or alloy 10 included in the forward shield portion 9. For example, the target 12 may be a thin film made of metal such as tungsten, molybdenum, chromium, copper, cobalt, iron, rhodium, rhenium, or the like, or alloy including any of the foregoing. The target 12 has a thickness of 1 μm to 15 μm, although the best value varies depending on situations because the depth to which the electron beam 14 enters the target 12, i.e., the size of a radiation generating region, varies with the acceleration voltage.

The substrate 11 supports the target 12 and transmits at least a portion of the radiation generated from the target 12. The substrate 11 is in contact with an atmosphere, insulating oil, or the like (not illustrated). The substrate 11 is preferably made of a material having a high transmittance with respect to radiation and a high thermal conductivity and being resistant to vacuum seal. For example, the substrate 11 can be made of diamond, silicon nitride, silicon carbide, aluminum carbide, aluminum nitride, graphite, beryllium, or the like. In particular, diamond, aluminum nitride, and silicon nitride each have a lower transmittance with respect to radiation than aluminum and a higher thermal conductivity than tungsten and are each suitable for forming the substrate 11. The substrate 11 has any thickness that satisfies the above functional conditions, for example, a thickness of 0.3 mm or larger and 2 mm or smaller depending on its material. Diamond has an extremely high thermal conductivity compared with other materials and has a high transmittance with respect to radiation. Furthermore, it is easy to retain a vacuum with diamond. Hence, diamond is superior. The thermal conductivity of the materials listed above tends to be reduced significantly with a rise of temperature. Therefore, the rise of temperature in the substrate 11 needs to be suppressed as much as possible.

The substrate 11 can be integrated with the target 12 by sputtering, vapor deposition, or other like technique. Alternatively, a thin film serving as the target 12 and having a predetermined thickness may be first formed by rolling or grinding, and the resultant body may be bonded to the substrate 11 by diffusion at a high temperature and a high pressure. The substrate 11 having the target 12 bonded thereto and the container 25 can be bonded to each other by brazing or the like.

The forward shield portion 9 has a radiation passage h (e.g., a hole or hollow space) that allows the radiation transmitted through the substrate 11 to pass therethrough. The forward shield portion 9 is connected to the substrate 11 and blocks an unnecessary portion of the radiation that has been transmitted through the substrate 11. Since the forward shield portion 9 is in contact with the atmosphere or the insulating oil or the like, the heat generated from the target 12 is dissipated quickly to the outside of the vacuum container 2. The forward shield portion 9 is made of any material that can block radiation generated at 30 kV to 150 kV, for example, a material such as tungsten, tantalum, molybdenum, zirconium, niobium, or the like or an alloy including any of the foregoing. The foregoing metals have high melting points, which is advantageous for safely conducting heat without deforming the same of forward shield portion 9. To that end, it is important that the forward shield portion 9 and the substrate 11 are thermally bonded to each other. While the forward shield portion 9 and the substrate 11 can be bonded by brazing, mechanical pressing, screwing, or the like, other well known machining techniques may be suitable. The melting point of a material used in brazing needs to be higher than the melting point of the low-melting-point metal or alloy 10, of course.

The low-melting-point metal or alloy 10, which is included in the forward shield portion 9 in the first embodiment, may alternatively be provided in any other way. In the case illustrated in FIG. 1B in which the low-melting-point metal or alloy 10 is provided in the shield member 13 in such a manner as to extend along the circumference of the target 12, the dissipation of the heat generated from the target 12 becomes uniform in the circumferential direction, improving the overall heat dissipation characteristic. Alternatively, partitions may be provided in the forward shield portion 9 such that the low-melting-point metal or alloy 10 is divided into a plurality of separate portions arranged in the circumferential direction. If such partitions are provided, the flow conductance of the low-melting-point metal or alloy 10 that has melted is limited. Therefore, even if the molten low-melting-point metal or alloy 10 spreads nonuniformly in the forward shield portion 9 because of the angle of the vacuum container 2 during the operation, the nonuniformity in the heat dissipation effect can be reduced.

The low-melting-point metal or alloy 10 may have a melting point of 50° C. or above and 500° C. or below, or more preferably 50° C. or above and 250° C. or below. If the low-melting-point metal or alloy 10 has a melting point of below 50° C., the low-melting-point metal or alloy 10 is difficult to handle in the manufacturing process. If the low-melting-point metal or alloy 10 has a melting point of above 250° C., the insulating oil tends to be decomposed. Examples of the low-melting-point metal or alloy 10 having a melting point that falls within the above range include indium (melting point: 157° C.), tin (melting point: 232° C.), a Bi—Pb alloy (melting point: 138° C.), a Sn—Pb alloy (melting point: 184° C.), and the like. Suppose that indium is used as the low-melting-point metal or alloy 10, for example. The heat of fusion of indium is 28.7 J/g. The density of indium is 7.3 g/cm³. Hence, if 1 cm³ of indium is provided, the heat of fusion is about 209 J/cm³.

FIG. 3 illustrates a graphical representation of how the low-melting-point metal or alloy 10 behaves when the electron beam 14 is applied to the target 12 and heat generated from the target 12 is transmitted through the substrate 11 and the forward shield portion 9 and melts the low-melting-point metal or alloy 10 included in the forward shield portion 9 by raising the temperature of the low-melting-point metal or alloy 10. In this state, a portion around an end 10a of the low-melting-point metal or alloy 10 nearer to the substrate 11 tends to have a high temperature because of the electron beam 14 applied to the target 12. A portion around an end 10b of the low-melting-point metal or alloy 10 farther from the substrate 11 is at a distance from the target 12 and is surrounded by the atmosphere or the insulating oil or the like (not illustrated). Therefore, heat is exchanged between the portion around the end 10b and the atmosphere or the insulating oil or the like. Hence, the end 10b of the low-melting-point metal or alloy 10 has a lower temperature than the end 10a nearer to the substrate 11. The temperature difference between the end 10a, near to the substrate 11, and the end 10b, relatively far from the substrate 11, of the low-melting-point metal or alloy 10 causes thermal convection, suppressing the rise of temperature in the low-melting-point metal or alloy 10. Consequently, the excessive rise of temperature in the target 12, the substrate 11, and the forward shield portion 9 is also suppressed. It is known that molten metal or alloy flows more easily than water. Accordingly, thermal convection sufficient for suppressing the rise of temperature occurs. In addition, it is known that under extreme heat water becomes vapor and eventually loses its effective volume (evaporates). In contrast the molten metal or alloy does not evaporate or lose its volume. Accordingly, thermal convection for reducing the rise of temperature in the target 12 and the substrate 11 can be effectively achieved.

The low-melting-point metal or alloy 10 can have a high capability of blocking radiation. For example, if tungsten is used as the target 12, the low-melting-point metal or alloy 10 may be any low-melting-point alloy containing lead or bismuth or may be a Bi—Pb alloy.

Now, a method of providing the low-melting-point metal or alloy 10 in the forward shield portion 9 will be described. First, the volume of low-melting-point metal or alloy 10 required is calculated from the heat of fusion, and the low-melting-point metal or alloy 10 is processed to have a predetermined size (or volume). Subsequently, a hole (not illustrated) for receiving the low-melting-point metal or alloy 10 having the predetermined size is provided in the forward shield portion 9, and the low-melting-point metal or alloy 10 is put into the hole. Then, the hole is covered with a lid made of the same material as the forward shield portion 9, and the two are brazed to each other. The material used for the brazing in sealing the hole has a higher melting point than the low-melting-point metal or alloy 10, of course.

The backward shield portion 8 has an electron-beam passage (e.g., a hole or hollow space) that allows the electrons emitted from the electron emitting source 3 to pass therethrough. The backward shield portion 8 is connected to the target 12 and blocks an unnecessary portion of the radiation scattering on a side of the target 12 facing the electron emitting source 3. Since radiation emitted toward the electron emitting source 3 through the electron-beam passage cannot be blocked, another blocking member may be provided separately. The backward shield portion 8 may also include a low-melting-point metal or alloy 10. The backward shield portion 8 can be made of the same material as the forward shield portion 9. That is, the materials of the backward shield portion 8 and the forward shield portion 9 may be the same or different. In addition, similar to the forward shield portion 9, the backward shield portion 8 may also include low-melting-point metal or alloy 10. The backward shield portion 8 and the target 12 can be bonded to each other by brazing or the like. The backward shield portion 8 is not an essential member of the radiation generating device, but can improve the effect of heat reduction and dissipation.

An exemplary case will now be described in which the radiation generating device 1 according to the first embodiment includes the low-melting-point metal or alloy 10 made of indium and is used for medical purposes. Advantageous effects produced in taking moving images performed by the radiation generating device 1 that is driven at an applied voltage of 100 kV and a current of 10 mA and for a pulsed irradiation time of 10 msec at a frequency of 10 Hz are as follows. The irradiation energy under the above driving conditions is expressed as “applied voltage×current×pulsed irradiation time×number of times of irradiation per second”. According to this expression, the irradiation energy comes to 100000 (V)×0.01 (A)×0.01 (sec)×10 (Hz)=100 (J). As described above, the heat of fusion of indium is about 209 J/cm³. Supposing that 1 cm³ of indium is provided, the rise of temperature is suppressed for about 2.1 seconds. Supposing that 10 cm³ of indium is provided, the rise of temperature is suppressed for about 21 seconds. This shows that it is effective to use the radiation generating device 1 for medical purposes. If the radiation generating device 1 is driven for a longer time, the indium entirely melts. The molten indium has a high temperature around an end nearer to the substrate 11 but has a low temperature around the opposite end because the heat is dissipated to the insulating oil through the forward shield portion 9. Since the molten indium has different temperatures in its different regions, thermal convection occurs and the rise of temperature is thus suppressed.

Another exemplary case will now be described in which the radiation generating device 1 according to the first embodiment includes the low-melting-point metal or alloy 10 made of indium and is applied to an X-ray microscope. Advantageous effects produced on an assumption that the radiation generating device 1 is continuously driven at an applied voltage of 100 kV and a current of 0.01 mA are as follows. According to the above expression, the irradiation energy under the above driving conditions comes to 100000 (V)×0.00001 (A)=1 (J). As described above, the heat of fusion of indium is about 209 J/cm³. Supposing that 1 cm³ of indium is provided, the rise of temperature is suppressed for about 209 seconds. Supposing that 10 cm³ of indium is provided, the rise of temperature is suppressed for about 2090 seconds. A radiation generating device applied to an X-ray microscope is used in an atmosphere. In such a case, the cooling effect is not expected to be as great as that produced in the case where the radiation generating device 1 is used in insulating oil. Nevertheless, since the irradiation energy is low, the radiation generating device 1 is satisfactorily practical.

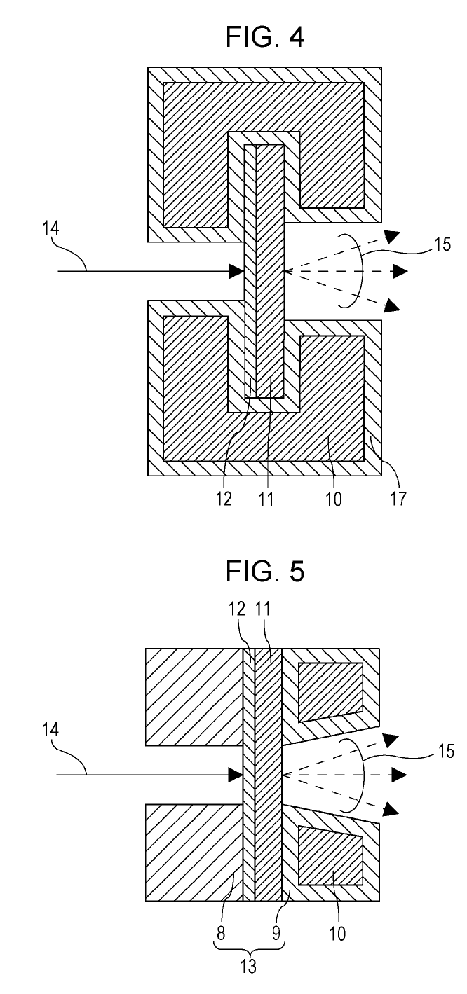

FIG. 4 is an enlarged sectional view illustrating a shield member 17 and associated elements included in a radiation generating device according to a second embodiment of the present invention. In the second embodiment, the shield member 17 includes a backward shield portion protruding in a direction toward the electron emitting source 3 with respect to the target 12, and a forward shield portion. Furthermore, the shield member 17 surrounds the target 12 and the substrate 11. The low-melting-point metal or alloy 10 is included in the shield member 17. The second embodiment differs from the first embodiment in that the low-melting-point metal or alloy 10 also resides in the backward shield portion, and the low-melting-point metal or alloy 10 residing in the forward shield portion and the low-melting-point metal or alloy 10 residing in the backward shield portion are continuous with each other. Except these differences, the radiation generating device according to the second embodiment is obtained with the same elements and configurations as the radiation generating device 1 according to the first embodiment. To provide the low-melting-point metal or alloy 10 in the shield member 17, the shield member 17 having an integral shape is prepared in advance. Then, a hole for receiving the low-melting-point metal or alloy 10 is provided by, for example, cutting. Alternatively, the shield member 17 having the hole may be obtained by pressing or sintering. According to the second embodiment, a larger volume of low-melting-point metal or alloy 10 can be provided. Therefore, the rise of temperature is further suppressed.

A certain gap may be interposed between the low-melting-point metal or alloy 10 and the shield member 17, i.e., between the low-melting-point metal or alloy 10 and the forward shield portion 9 and/or between the low-melting-point metal or alloy 10 and the backward shield portion 8. In such an embodiment in which a certain gap is provided, even if there are any local variations in the flow characteristic of the low-melting-point metal or alloy 10 or any local expansion of the low-melting-point metal or alloy 10 in the shield member 17, or even if any gas is generated from the low-melting-point metal or alloy 10, resultant pressure variations can be reduced.

FIG. 5 is an enlarged sectional view illustrating a shield member 13 and associated elements included in a radiation generating device according to a third embodiment of the present invention. The third embodiment differs from the first embodiment in that the opening area of the radiation passage provided in the forward shield portion 9 of the shield member 13, illustrated in FIG. 2, gradually increases from a side thereof nearer to the substrate 11 toward the front side. Except this difference, the radiation generating device according to the third embodiment is obtained with the same elements and configurations as the radiation generating device 1 according to the first embodiment. Furthermore, the radiation generating device according to the third embodiment is manufactured by the same method as the radiation generating device 1 according to the first embodiment. According to the third embodiment, the area of contact between the forward shield portion 9 and the substrate 11 and the area of projection of the low-melting-point metal or alloy 10 on the substrate 11 are increased. Therefore, the thermal conductivity from the substrate 11 to the forward shield portion 9 and the low-melting-point metal or alloy 10 is increased. Hence, the rise of temperature is further suppressed.

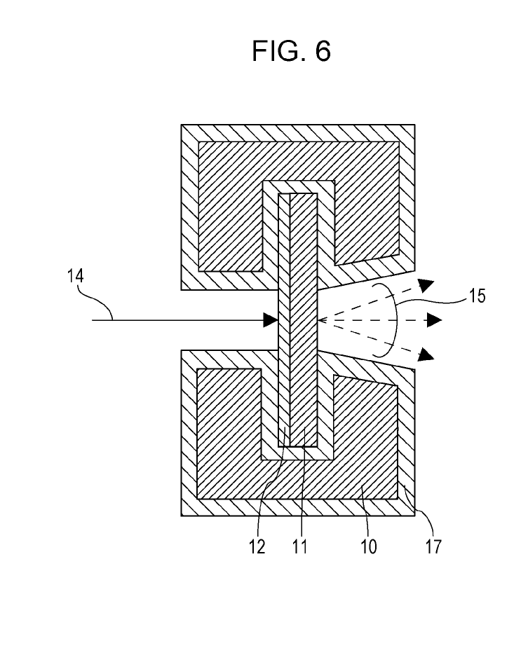

FIG. 6 is an enlarged sectional view illustrating a shield member 17 and associated elements included in a radiation generating device according to a fourth embodiment of the present invention. In the fourth embodiment, the shield member 17 includes a backward shield portion and a forward shield portion, and surrounds the target 12 and the substrate 11. The low-melting-point metal or alloy 10 is provided in the shield member 17. The fourth embodiment differs from the third embodiment in that the low-melting-point metal or alloy 10 also resides in the backward shield portion, and the low-melting-point metal or alloy 10 residing in the forward shield portion and the low-melting-point metal or alloy 10 residing in the backward shield portion are continuous with each other. Except these differences, the radiation generating device according to the fourth embodiment is obtained with the same elements and configurations as the radiation generating device 1 according to the third embodiment. According to the fourth embodiment, a much larger volume of low-melting-point metal or alloy 10 can be provided. Therefore, the rise of temperature is further suppressed.

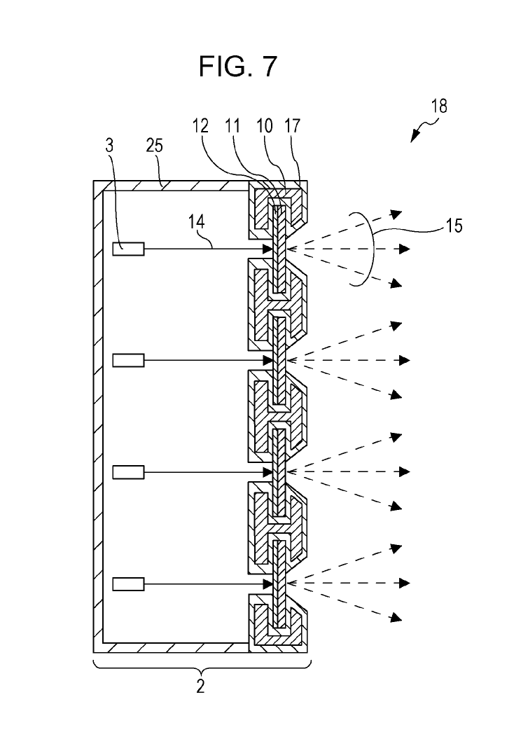

FIG. 7 is a sectional view of a radiation generating device 18 according to a fifth embodiment of the present invention. In the fifth embodiment, the low-melting-point metal or alloy 10 included in the shield member 17 continuously extends over adjacent ones of a plurality of radiation generating regions. The low-melting-point metal or alloy 10 may be included only in the forward shield portion or both in the backward shield portion and in the forward shield portion separately. The radiation generating device 18 according to the fifth embodiment is a multiple radiation generating device including a plurality of units each including the electron emitting source 3 and the substrate 11, the target 12, the shield member 17, and the low-melting-point metal or alloy 10 illustrated in FIG. 6. The units may be arranged in a line or in a plane. The shield member, the low-melting-point metal or alloy, the substrate, and the target included in the radiation generating device according to any of the first to fourth embodiment can be employed in the fifth embodiment. The fifth embodiment produces the same advantageous effects as the first to fourth embodiments.

In the multiple radiation generating device according to the fifth embodiment including a plurality of radiation generating regions, the low-melting-point metal or alloy 10 included in the shield member 17 continuously extends over adjacent ones of the plurality of radiation generating regions. The present invention also encompasses an embodiment in which separate regions each including the low-melting-point metal or alloy 10 are allocated to the respective radiation generating regions that are adjacent to each other.

In the embodiment in which the low-melting-point metal or alloy 10 continuously extends over adjacent ones of a plurality of radiation generating regions, even if there are variations in the heat generation from the plurality of targets 12, such variations tend to become uniform over the entirety. Such a configuration is suitable for a case in which scanning is performed by using a plurality of electron emitting sources 3. In the embodiment in which separate regions each including the low-melting-point metal or alloy 10 are allocated to the respective radiation generating regions that are adjacent to each other, different kinds of low-melting-point metal or alloy 10 may be provided in accordance with the amounts of heat dissipation from the respective targets 12.

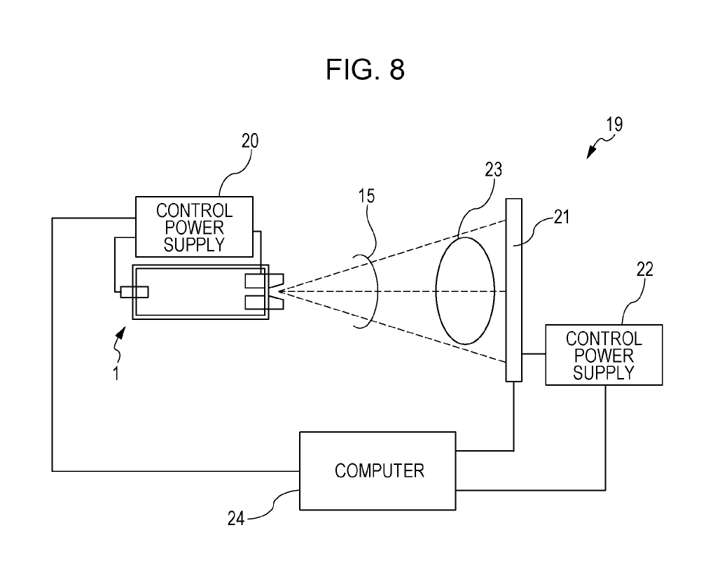

A sixth embodiment of the present invention concerns a radiography apparatus including the radiation generating device according to any of the above embodiments of the present invention. FIG. 8 is a schematic diagram of a radiography apparatus 19 according to the sixth embodiment.

The radiography apparatus 19 according to the present embodiment is a combination of the radiation generating device 1, a control power supply 20 that drives the radiation generating device 1, a radiation sensor 21, and a computer 24 intended for imaging data display and image analysis. The radiation generating device 1 serves as a radiation source for the radiography apparatus 19, and may be based on any of the first to fifth embodiments described above.

The radiation generating device 1 is driven by the control power supply 20 provided for the radiation generating device 1, thereby generating radiation. The control power supply 20 is configured to implement operations including application of voltages to a circuit from which a high voltage is applied between the cathode and the anode, the electron emitting source, the grid electrode, the focusing electrode, and so forth. The radiation sensor 21 is controlled by a control power supply 22 provided for the radiation sensor 21 and acquires imaging information on an object 23 positioned between the radiation sensor 21 and the radiation generating device 1. The imaging information thus acquired is displayed on the computer 24 intended for image data display and image analysis. The radiation generating device 1 and the radiation sensor 21 are controlled in conjunction with each other in accordance with an intended image, such as a still image or a moving image, differences in site to be imaged, and so forth. The computer 24 is also capable of analyzing images and comparing current data with past data. To that end, the computer 24 may use one or more microprocessors (not shown), which can be programmed with specific algorithms, to implement the required circuit control and image processing.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-252792 filed Nov. 18, 2011, which is hereby incorporated by reference herein in its entirety.

What is claimed is:

1. A transmission type radiation generating device comprising:
an electron emitting source configured to generate an electron beam;
a substrate that transmits radiation;
a target provided on a surface of the substrate facing the electron emitting source and configured to generate radiation when electrons emitted from the electron emitting source are applied thereto;
a shield member having a radiation passage that allows the radiation transmitted through the substrate to pass therethrough, the shield member being connected to the substrate and including at least a forward shield portion that protrudes in a direction away from the electron emitting source with respect to the target; and
an insulating fluid in contact with the forward shield portion,
wherein the shield member includes a low-melting-point metal or a low-melting-point alloy provided at least in the forward shield portion.

2. The transmission type radiation generating device according to claim 1, wherein the shield member further includes a backward shield portion protruding in a direction toward the electron emitting source with respect to the target.

3. The transmission type radiation generating device according to claim 2, wherein the low-melting-point metal or the low-melting-point alloy is also provided in the backward shield portion.

4. The transmission type radiation generating device according to claim 3, wherein the low-melting-point metal or the low-melting-point alloy provided in the forward shield portion is continuous with the low-melting-point metal or the low-melting-point alloy provided in the backward shield portion.

5. The transmission type radiation generating device according to claim 1, wherein the low-melting-point metal or the low-melting-point alloy is provided in the shield member in such a manner as to extend along a circumference of the target.

6. The transmission type radiation generating device according to claim 1, wherein the low-melting-point metal or the low-melting-point alloy is divided into separate portions with at least one partition.

7. The transmission type radiation generating device according to claim 1, wherein a gap is provided between the low-melting-point metal or the low-melting-point alloy and the shield member.

8. The transmission type radiation generating device according to claim 1, wherein opening area of the radiation passage provided in the forward shield portion gradually increases from a side adjacent to the substrate toward a front side thereof.

9. The transmission type radiation generating device according to claim 1, wherein the low-melting-point metal or the low-melting-point alloy has a melting point of 50° C. or above and 500° C. or below.

10. The transmission type radiation generating device according to claim 9, wherein the low-melting-point alloy is a Bi—Pb alloy.

11. The transmission type radiation generating device according to claim 1, wherein the substrate is made of diamond.

12. The transmission type radiation generating device according to claim 1, wherein a plurality of units each including the electron emitting source, the substrate, the target, the shield member, and the low-melting-point metal or the low-melting point alloy are combined such that a plurality of radiation generating regions are provided adjacent to one another.

13. The transmission type radiation generating device according to claim 12, wherein the low-melting-point metal or the low-melting point alloy continuously extends over adjacent ones of the plurality of radiation generating regions.

14. The transmission type radiation generating device according to claim 12, wherein the low-melting-point metal or the low-melting point alloy includes a plurality of separate portions that are allocated to the respective radiation generating regions.

15. A radiography apparatus comprising:
the transmission type radiation generating device according to claim 1;
a control power supply that drives the transmission type radiation generating device;
a radiation sensor; and
a computer that displays imaging data and performs image analysis.

16. A transmission type radiation generating source comprising:
an electron emitting source configured to generate an electron beam;
a substrate that transmits radiation therethrough;
a target provided on a surface of the substrate facing the electron emitting source and configured to generate radiation in response to the electron beam emitted from the electron emitting source impinging thereupon; and
a shield member having a radiation passage and configured to allow the radiation transmitted through the substrate to pass therethrough, the shield member being attached to the substrate and including a forward shield portion that extends in a direction in which the radiation propagates,
wherein the shield member includes a low-melting-point metal or a low-melting-point alloy provided inside the forward shield portion.
